(19) United States
(12) Patent Application Publication
(10) Pub. No.: US 2021/0155838 A1
(43) Pub. Date: May 27, 2021

(54) DUST AND INTEGRITY CONTROL COMPOSITIONS

(71) Applicant: MCTRON TECHNOLOGIES, Greenville, SC (US)

(72) Inventor: Billy Andrew McDaniel, Greenville, SC (US)

(73) Assignee: MCTRON TECHNOLOGIES, GREENVILLE, SC (US)

(21) Appl. No.: 17/100,910

(22) Filed: Nov. 22, 2020

Related U.S. Application Data
(60) Provisional application No. 62/940,091, filed on Nov. 25, 2019.

(51) Int. Cl. C09K 3/22; E21F 5/18; E01B 19/00

(52) U.S. Cl. CPC C09K 3/22; E01B 19/00; E21F 5/18

(57) ABSTRACT

The present disclosure relates to water-soluble binder compositions comprising at least one carbohydrate component and at least one nitrogen-containing compound. In addition, methods for manufacturing the disclosed compositions, as well as methods for reducing or eliminating particulate generation and/or exothermic heat production associated with mineable compositions such as coal, are provided.

### SUMMARY OF THE INVENTION

The present disclosure relates to water-soluble binder compositions, as well as methods for producing and utilizing the disclosed compositions. Chemical binders, which are often referred to simply as “binders,” are commercially utilized for myriad applications. One such class of binders are carbohydrate based binders, which may be derived from reacting a carbohydrate and an amine and/or a polyamine, more specifically a polyamine having at least one primary amine group, in order to form polymeric carbohydrate (poly)amine binders. Carbohydrate based binder compositions may beneficially comprise relatively inexpensive precursors derived from renewable resources. Carbohydrate polyamine binders are generally prepared as a solution, including but not limited to an aqueous solution, and applied to a composition or article of interest.

The energy and mining industries utilize binder/adhesive compositions for best maintaining the physical integrity of minable ores such as coal and minerals. Such binder/adhesive compositions may be used to prevent or suppress mineral/ore dust formation, maintain mineral/ore integrity during processing and transportation, and minimize financial loss associated with these and other problems.

Accordingly, the present disclosure provides for dispersible (e.g. sprayable) carbohydrate and amine based binder compositions which address some of the aforementioned challenges. For instance, in some embodiments the disclosed technology encompasses a curable, dispersible binder (alternatively referred to herein as an adhesive) composition comprising: (a) at least one carbohydrate component; (b) at least one amine component; and (c) at least one carbohydrate reaction product comprising at least one or more reaction products of at least one carbohydrate component with at least one amine component; wherein the composition is dispersible under ambient temperature and pressure conditions, and wherein the curable binder composition is capable of eliminating or reducing moisture loss when applied to an article or composition of matter.

In additional embodiments, the at least one carbohydrate component of the binder (alternatively referred to as an adhesive) is selected from the group consisting of dextrin, cyclodextrin, branched cyclodextrin, maltodextrin, amylodextrin, alpha (α)-limit dextrin, beta (β)-limit dextrin, British gum, canary/yellow dextrin, icodextrin, starch, modified starch, monosaccharides, disaccharides, polysaccharides, reducing sugars, ribose, arabinose, xylose, lyxose, glucose (dextrose), mannose, galactose, allose, altrose, talose, gulose, idose, fructose, psicose, sorbose, dihydroxyacetone, sucrose, tagatose, mixtures thereof and reaction products thereof.

In some embodiments, the at least one amine component comprises an inorganic amine or an organic amine comprising at least one primary amine group, as well as salts thereof. In certain embodiments, the polyamine comprises a primary polyamine of the general formula H₂N-Q-NH₂, wherein Q is selected from an alkyl, carbonyl, cycloalkyl, heteroalkyl, cycloheteroalkyl, benzyl, a C₆ alkyl or cyclohexyl, cyclopentyl, cyclobutyl, or benzyl, optionally substituted with amino, aminoalkyl, hydroxyl, halo, or thiol, wherein alkyl is selected from the group consisting of C₂-C₂₄ alkyl, C₂-C₉ alkyl, and C₃-C₇ alkyl. In certain embodiments, the at least one amine component comprises urea.

In further embodiments, the instant disclosure provides for minable ore comprising the disclosed curable binder composition. In still further embodiments, the minable ore is selected from the group consisting of coal, oil shale, metals, gemstones, limestone, chalk, dimension stone, rock salt, potash, gravel, clay and combinations thereof. In additional embodiments, the minable ore and curable binder composition are capable of forming a char or partial burn layer under mild ignition conditions, and the curable binder composition forms a continuous film or layer when applied to the minable ore. As would be appreciated by those of skill in the relevant art, such char or partial burn layers may beneficially eliminate or reduce the risk for spontaneous combustion events in carbonaceous matter such as coal. In certain embodiments, a grain or track ballast comprises the curable binder composition of the present disclosure, and the curable binder composition forms a continuous film or layer when applied to the grain or track ballast.

In some embodiments, methods of manufacturing the disclosed curable binder composition are provided, comprising the steps of: (i) providing at least one carbohydrate component; (ii) providing at least one amine component; (iii) introducing the at least one carbohydrate component into a vessel comprising a solvent or solvent system under stirring and applied heating conditions; and (iv) introducing the at least one amine component to the at least one carbohydrate component/solvent or solvent system solution under stirring and applied cooling conditions. In some embodiments, the disclosed curable binder solution or dispersion is provided in a solvent or solvent system, which may comprise one or more of water, alcohol, methanol, ethanol, propanol, butanol, ammonia and combinations thereof.

In additional embodiments, the present disclosure relates to a curable binder composition obtainable by combining a) at least 1% by dry weight dextrin; and b) at least 1% by dry weight urea. In further embodiments, the binder composition consists of a binder composition obtainable by combining reactants consisting of 1-10% by dry weight dextrin and 20-40% by dry weight urea, including 3-5% by dry weight dextrin and 25-35% by dry weight urea.

In some embodiments, the disclosure relates to minable ores comprising the binder or adhesive selected from the group consisting of minable ore, e.g. coal, oil shale, metals, gemstones, limestone, chalk, dimension stone, rock salt, potash, gravel, and clay, as well as combinations thereof. In further embodiments, the binder composition or adhesive comprises one or more starch carbohydrate components such as dextrin and/or chemically functionalized dextrin(s), and is capable of being crosslinked in the presence of an amine

In still further embodiments, the disclosed composition is biodegradable and biorenewably sourced, i.e. the composition comprises chemical components derived from biological, renewable and/or organic sources and does not comprise components derived from fossil fuel sources or derivatives.

In additional embodiments, the composition, e.g. a minable ore, grain or track ballast, is characterized by enhanced physical, chemical and/or thermal stability and resists degradation during processing, transport and storage. In some embodiments, the composition comprising the binder/adhesive disclosed herein may be processed, transported and/or stored and remains chemically stable for a period of at least 12 hours, at least 24 hours, at least 96 hours, at least 1 week, at least 2 weeks, at least 4 weeks, at least 30 days, and at least 90 days.

In some embodiments, the binder composition/adhesive advantageously cures under ambient temperatures and pressures when applied to the commercial compositions described herein, including but not limited to minable ores such as such as coal, oil shale, metals, gemstones, limestone, chalk, dimension stone, rock salt, potash, gravel, and clay, as well as grains and track ballast. The binder composition/adhesive may beneficially eliminate and/or reduce the risk of one or more of events such as fissuring, spontaneous combustion, deleterious oxidation, drying and dust/particulate formation that adversely affect the environmental, economic and/or human and animal health risks associated with the processing, loading and/or transport of minable ores, grains and track ballast as described herein.

### DETAILED DESCRIPTION OF THE INVENTION

The present disclosure provides for curable, dispersable binder compositions that impart commercially beneficial properties to minable ores such as coal, oil shale, metals, gemstones, limestone, chalk, dimension stone, rock salt, potash, gravel, and clay. In some embodiments, these properties include but are not limited to moisture retention, weather resistance, wind damage resistance (particular during the transport of minable ores such as coal) and thermal dissipation and/or suppression within the minable ore, e.g. within a mass/collection of coal and/or on the surface of the same. In additional embodiments, production and dispersion methods for the compositions disclosed herein are provided.

Without being bound by theory, it has been found that when introducing a dispersible binder/adhesive compound capable of forming a film or monolayer upon its introduction to the surface and/or the bulk content of a minable ore, e.g. coal, oil shale, metals, gemstones, limestone, chalk, dimension stone, rock salt, potash, gravel, and clay, the minable ore is advantageously protected from physical and/or thermal degradation during the processing, loading and/or transport of the same.

The term “binder composition,” or simply “binder” (or “adhesive composition,” or simply “adhesive”) as used herein means all ingredients that comprise the curable (binder) composition and that will be applied to the (target) composition(s) of interest, e.g. minable ore compositions such as coal, oil shale, metals, gemstones, limestone, chalk, dimension stone, rock salt, potash, gravel, and clay, including reactants, solvents (including water) and additives. The term “dry weight of the binder composition” as used herein means the weight of all components of the binder composition other than any water that is present (whether in the form of liquid water or in the form of water of crystallization). In certain embodiments, the non-aqueous reactants may make up greater than or equal to at least about 20%, including at least about 30%, about 35% or at least about 40% by dry weight of the binder composition.

In some embodiments, the binder composition(s) disclosed herein may be applied to one or more minable ore compositions such as coal, oil shale, metals, gemstones, limestone, chalk, dimension stone, rock salt, potash, gravel, and clay, for preserving the minable ore compositions during the mining, extraction, processing and/or transport of the compositions.

The total amount of the at least one carbohydrate component and the at least one amine (nitrogen-containing) component of the starting material for the preparation of the binder composition may be at least 5% by weight (5 wt. %), based on the binder solids content or on the total dry weight of the binder composition. For example, the total amount of the at least one carbohydrate component and the at least one amine (nitrogen-containing) component may be at least about 0.1 wt. %, about 0.2 wt. %, about 0.5 wt. %, about 1 wt. %, about 2 wt. %, about 5 wt. %, about 10 wt. %, about 20 wt. %, about 25 wt. %, about 30 wt. %, about 35 wt. %, about 40 wt. % and about 50 wt. %.

As used herein, the term “water-soluble” may include all gradations and ratings of water-solubility of the disclosed binder composition. For instance, the term “water-soluble” includes water-solubility at ambient conditions (e.g. at about 25° C. (about 77° F.) and about 1 atm (about 760 mm Hg)) of about 100 g/l (about 0.8 lb/gal) or more, about 150 g/l (about 1.3 lb/gal) or more, about 200 g/l (about 1.7 lb/gal) or more, about 250 g/l (about 2.1 lb/gal) or more, about 300 g/l (about 2.5 lb/gal) or more, about 400 g/l (about 3.3 lb/gal) or more, about 500 g/l (about 4.2 lb/gal) or more, and about 600 g/l (about 5.0 lb/gal) or more.

In some embodiments, the concentration and/or the viscosity of the disclosed binder/adhesive compositions can be manipulated to increase the surface coverage and/or penetration of the binder/adhesive when applied to the surface and/or the bulk content of the minable ore, e.g. coal. For example, in non-limiting embodiments the viscosity of the binder/adhesive is about 1 centipoise (cP) to about 1000 cP, including about 1-100 cP, and about 1-10 cP.

In alternative embodiments, the concentration and/or viscosity of the disclosed binder/adhesive solution may be altered (either diluted or increased), e.g. to increase or decrease the surface coverage and/or penetration of the binder solution into an article or composition of matter. For example, in some embodiments the disclosed binder may be diluted at a water:binder weight ratio of about 50:1, about 100:1, about 150:1, about 200:1, about 250:1 and about 300:1.

As used herein, the term “dust” may include any particulate, pollutant and/or fine particle(s) of solid or semi-solid matter generated during the processing, loading and/or transport of an article or composition of matter as described herein, including but not limited to minable ores, coal, oil shale, metals, gemstones, limestone, chalk, dimension stone, rock salt, potash, gravel, clay, grain, track ballast and combinations thereof. For instance, the mass loading and/or transport of coal following its extraction is known to generate significant amounts of dust, e.g. during the introduction of coal into an open rail car and during its subsequent transport via rail transit due to wind exposure, vibrations and perturbations during transit, et al.

In some embodiments, the disclosed binder/adhesive composition may beneficially perform as a humectant when applied to an article or composition of matter. The term “humectant” as used herein refers to a composition that reduces moisture loss when applied to an article or composition of matter, including a minable ore, coal, oil shale, metal, gemstone, limestone, chalk, dimension stone, rock salt, potash, gravel, clay, grain and/or track ballast. For example, when the binder/adhesive of the present disclosure is applied to coal, the endogenous moisture present therein is beneficially retained and advantageously prevents or reduces deleterious events such as spontaneous combustion, including “hot spotting,” within the coal.

As used herein, the term “crosslinker” may comprise any chemical or physical means to crosslink the binder composition to yield a polymeric binder capable of binding loosely assembled matter, such as mineral fibers. According to a specific embodiment of the present disclosure, the crosslinker may be the same amine component(s) which has been reacted with the carbohydrate component, or may be a different component capable of performing as a crosslinker. In certain embodiments, crosslinkers such as those available from MCTRON™ Technologies (Greenville, S.C., USA) under the commercial line MaxxLink® may be utilized.

A binder composition of the present disclosure may be prepared, in some embodiments, by mixing a carbohydrate component with urea under stirring conditions. Subsequently, further urea may be added to the binder composition to achieve the high grade of polymerization required in the respective polymerized application. In alternative embodiments, urea may be substituted for one or more of urea based derivatives, melamine, triethanolamine (TEA), ammonia and ammonia-based amides, acrylonitrile polymers and pentaerythritol.

The term “carbohydrate component,” as used herein, is not specifically restricted and generally includes any carbohydrate compound(s) capable of chemically reacting with a nitrogen-containing component, e.g. an amine as described herein, under relevant reaction and curing conditions. In some embodiments, the at least one carbohydrate component is selected from the group consisting of dextrin, cyclodextrin, branched cyclodextrin, maltodextrin, amylodextrin, alpha (α)-limit dextrin, beta (β)-limit dextrin, British gum, canary/yellow dextrin, icodextrin, starch, modified starch, monosaccharides, disaccharides, polysaccharides, pearl starch, polyvinyl alcohols (PVOHs), polyacrylimides, carboxymethyl cellulose (CMC), Hydroxyethyl Cellulose (HEC), guar gum, xanthan gum, polyacrylic polymers, latex acrylic, styrene acrylic, vinyl acetate, vinyl acrylic, styrene butadiene rubber emulsions, vinyl acetate ethylene polymers, reducing sugars, ribose, arabinose, xylose, lyxose, glucose (dextrose), mannose, galactose, allose, altrose, talose, gulose, idose, fructose, psicose, sorbose, dihydroxyacetone, sucrose, tagatose, mixtures thereof and reaction products thereof, combinations thereof and reaction product(s) thereof. For instance, in non-limiting embodiments the carbohydrate component comprises one or more dextrin(s) and/or a component that generates one or more functionalized dextrin(s) in situ.

In accordance with some embodiments of the present disclosure, a carbohydrate component may be optionally substituted with, e.g. one or more hydroxyl, halyl/halo, alkyl and/or alkoxyl groups further comprising one or more chiral centers, wherein optical isomers at each chiral center may be present. In additional embodiments, various mixtures such as racemic mixtures and other diastereomeric mixtures of the various optical isomers of the carbohydrate component, as well as various geometric isomers thereof, may be used.

In some embodiments, the binder composition may comprise a resin and/or additional, optional reactants thereof selected from surfactants, latex resin, cellulose-based resin such as carboxymethyl-cellulose (CMC)-based resin, starch-based resin and combinations thereof. In certain embodiments, surfactants comprising dioctyl sulfosuccinate (DOSS), including but not limited to DOSS surfactants available from JLK Industries (Coopersburg, Pa., USA) and sold under the name “JDOSS,” may be incorporated into the binder composition. In further embodiments, the binder composition may comprise at least 10% by weight (10 wt. %), at least 20 wt. %, at least 30 wt. %, at least 35 wt. %, at least 40 wt. % or at least 50 wt. % by dry weight of the resin and/or reactants thereof.

In accordance with the present technology, any carbohydrate component(s) should be sufficiently nonvolatile to maximize reactivity with the amine (nitrogen-containing) component. As used herein, an amine may refer to a “polyamine,” which may include any two or more nitrogen-containing groups in the nitrogen-containing component which are capable of reacting with the carbohydrate component under binder curing conditions, and which may be optionally and/or individually substituted. Examples of such reactive nitrogen-containing groups include but are not limited to secondary, tertiary and quaternary amine groups, amide groups, imine and imide groups, as well as cyanate and isocyanate groups. In a further embodiment, the nitrogen-containing component may include a polymeric polyamine. For example, polymeric polyamines within the scope of the present technology include chitosan, polylysine, polyethylenimine, poly(N-vinyl-N-methyl amine), polyaminostyrene and polyvinylamines In a specific example, the nitrogen-containing component comprises a polyvinyl amine As used herein, the polyvinyl amine can be a homopolymer or a copolymer.

In addition, any type of polyamine based inorganic and organic ammonium salts capable of reacting with the carbohydrate components described herein may be used in the present technology. Non-limiting examples of inorganic ammonium salts include polyamide salts (e.g., diammonium and triammmonium salts) and single amide, chemically reactive sites of a polyamide such as ammonium sulfate (AmSO₄), ammonium phosphate (e.g. diammonium phosphate and ammonium citrate), ammonium chloride, ammonium nitrate and derivatives thereof.

As used herein, an amine may refer to a “primary polyamine,” which is an organic compound comprising two or more primary amine groups (—NH₂). As defined herein, a primary polyamine may comprise a compound capable of being modified in situ, or isomerized to generate a compound that transiently or ultimately comprises two or more primary amine groups (—NH₂). In certain embodiments, the primary polyamine comprises the general formula H₂N-Q-NH₂, where Q is an alkyl, cycloalkyl, heteroalkyl, or cycloheteroalkyl group, each of which may be optionally substituted. In non-limiting examples, Q may comprise an alkyl group selected from a group consisting of a C₂-C₂₄ group, an alkyl selected from a group consisting of a C₂-C₉ group, and an alkyl selected from a group consisting of C₃-C₇ group, such as a C₆ alkyl group, a cyclohexyl, a cyclopentyl, a cyclobutyl, or a benzyl group.

In some embodiments, the primary polyamine may comprise a triprimary triamine having chemical spacer groups between each of the three primary amines As used herein, a triprimary triamine is an organic compound limited to three amine groups, each comprising a primary amine (—NH₂). Accordingly, in embodiments of the present disclosure, the triprimary triamine(s) may be selected from triprimary triamine(s) having spacer groups between each of the three primary amines in which spacer groups consist of carbon chains; triprimary triamine(s) having spacer groups between each of the three primary amines wherein each spacer group has a spacer length which is less than or equal to 12 polyvalent atoms; and triprimary triamine(s) having a total number of polyvalent atoms of less than or equal to 23. As described herein, a triprimary triamine having spacer groups between each of the three primary amines wherein spacer groups consist of carbon chains means that the spacer groups comprise carbon atoms bonded to hydrogen atoms or to other carbon atoms.

The spacer group(s) may be selected from the group consisting of alkanediyls, heteroalkanediyls, alkenediyls, heteroalkenediyls, alkynediyls, heteroalkynediyls, linear alkanediyls, linear heteroalkanediyls, linear alkenediyls, linear heteroalkenediyls, linear alkynediyls, linear heteroalkynediyls, cycloalkanediyls, cycloheteroalkanediyls, cycloalkenediyls, cycloheteroalkenediyls, cycloalkynediyls and cycloheteroalkynediyls, each of which may be branched or unbranched. The spacer group(s) may be selected from the group consisting of alkanediyls, alkenediyls, alkynediyls, linear alkanediyls, linear alkenediyls, linear alkynediyls, cycloalkanediyls, cycloalkenediyls and cycloalkynediyls, each of which may be branched or unbranched. The spacer group may comprise or may be devoid of halogen atoms. The spacer groups may comprise or be devoid of aromatic groups. As used herein: the term “alkanediyl” means a saturated chain of carbon atoms ie without carbon-carbon double or triple bonds; the term “alkenediyl” means a chain of carbon atoms that comprises at least one carbon-carbon double bond; the term “alkynediyl” means a chain of carbon atoms that comprises at least one carbon-carbon triple bond; the term “cyclo” in relation to cycloalkanediyl, cycloalkenediyl and cycloalkynediyl indicates that at least a portion of the chain is cyclic and also includes polycyclic structures; and the term “linear” in relation to alkanediyls, alkenediyls and alkynediyls indicates an absence of a cyclic portion in the chain. As used herein, the term “hetero” in relation to heteroalkanediyls, heteroalkenediyls, heteroalkynediyls, linear heteroalkanediyls, linear heteroalkenediyls, linear heteroalkynediyls, cycloheteroalkanediyls, cycloheteroalkenediyls, and cycloheteroalkynediyls means that the chain comprises at least one polyvalent heteroatom. As used herein, the term heteroatom is any atom that is not carbon or hydrogen.

As used herein, the term polyvalent atom means an atom capable of being covalently bonded to at least two (2) other atoms. The polyvalent heteroatom may be oxygen; it may be silicon; it may be sulfur or phosphorus. One, two or preferably each of the spacer groups may have a total number of polyvalent atoms, or a total number of carbon atoms which is greater than or equal to 3, 4 or 5, and/or less than or equal to 12, 10 or 9. In some embodiments, one, two or all (each) of the spacer groups may have a spacer length which is greater than or equal to 3, 4 or 5, and/or less than or equal to 12, 10 or 9. As used herein, the term “spacer length” in relation to a spacer group separating two primary amines means the number of polyvalent atoms which form the shortest chain of covalently bonded atoms between the two primary amines.

In certain embodiments, a triprimary triamine(s) for use in the disclosed technology is selected from the group consisting of triaminodecanes, triaminononanes (TANs), 4-(aminomethyl)-1,8-octanediamine, triaminooctanes, triaminoheptanes, 1,4,7-triaminoheptane, triaminohexanes, 1,3,6-triaminohexane, triaminopentanes, isomers thereof, and combinations thereof.

As used herein, the term “alkyl” includes a chain of carbon atoms, which may optionally be branched. As used herein, the terms “alkenyl” and “alkynyl” independently include a chain of carbon atoms, which may optionally be branched, and include at least one double bond or triple bond, respectively. In the context of the disclosed technology, an alkynyl group may comprise one or more double bonds, and may be selected from one or more C₁-C₂₄, C₁-C₁₂, C₁-C₈, C₁-C₆, and C₁-C₄ groups, including C₂-C₂₄, C₂-C₁₂, C₂-C₈, C₂-C₆, and C₂-C₄ groups. While not limiting the scope of the present technology, the skilled artisan would appreciate that shorter alkyl, alkenyl, and/or alkynyl groups may add less hydrophilicity to the binder/adhesive composition and modify the reactivity of the composition with the carbohydrate component, as well as modifying the solubility of the binder/adhesive composition.

As used herein, the term “cycloalkyl” refers to alkyl compounds comprising a chain of carbon atoms, which may optionally be branched, where at least a portion of the chain is cyclic, and may further comprise “cycloalkyl alkyl (or “cycloalykl-alkyl)” and polycyclic structures. In non-limiting examples, cycloalkyls may be selected from the group consisting of cyclopropyl, cyclopentyl, cyclohexyl, 2-methylcyclopropyl, cyclopentyleth-2-yl, adamantyl and related chemical groups. As defined herein, the term “cycloalkenyl” comprises a chain of carbon atoms, which may optionally be branched, and includes at least one double bond, and where at least a portion of the chain is cyclic.

In accordance with the instant disclosure, the one or more double bonds may be in the cyclic portion and/or the non-cyclic portion of the cycloalkenyl group, as well as in the subset of cycloalkenyl alkyl and cycloalkyl alkenyl groups. In addition, a cycloalkyl group for use in the present technology may be polycyclic. Examples of such cycloalkenyls include, but are not limited to, cyclopentenyl, cyclohexylethen-2-yl, cycloheptenylpropenyl and related groups. In certain embodiments, the chain length of a cycloalkyl and/or cycloalkenyl group may be limited and comprise one of a C₃-C₂₄, C₃-C₁₂, C₃-C₈, C₃-C₆, or C₅-C₆ chain length. As would be appreciated by the skilled artisan, an alkyl and/or alkenyl chain for use in a cycloalkyl and/or cycloalkenyl group, respectively, may beneficially modify the lipophilicity of the compound for tuning the resulting binder/adhesive compositional properties.

As used herein, a “heteroalkyl” encompasses an optionally branched chain of atoms comprising both carbon and at least one heteroatom. Examples of such heteroatoms include but are not limited to nitrogen, oxygen, sulfur, phosphorus and selenium. In one embodiment, the heteroalkyl group comprises a polyether. As used herein, the term “cycloheteroalkyl” includes both heterocyclyl and heterocycle groups, and may further include one or more chains of atoms comprising both carbon and at least one heteroatom, such as heteroalkyl group, and may optionally be branched, wherein at least a portion of the chain is cyclic. Non-limiting examples of a cycloheteroalkyl include, but are not limited to, tetrahydrofuryl, pyrrolidinyl, tetrahydropyranyl, piperidinyl, morpholinyl, piperazinyl, homopiperazinyl, quinuclidinyl and related groups.

In accordance with the instant disclosure, “optionally substituted” refers to the chemical substitution or replacement of hydrogen atoms with other functional groups on the radical that is optionally substituted. Examples of these functional groups include amino, hydroxyl, halo, thiol, alkyl, haloalkyl, heteroalkyl, aryl, arylalkyl, arylheteroalkyl, nitro, sulfonic acids and derivatives thereof, and carboxylic acids and derivatives thereof. In additional embodiments, any of amino, hydroxyl, thiol, alkyl, haloalkyl, heteroalkyl, aryl, arylalkyl, arylheteroalkyl, and/or sulfonic acid functional groups may be optionally substituted.

In some embodiments, the amine component may comprise a primary polyamine that may be selected from a diamine, triamine, tetraamine, or pentamine According to one embodiment, the polyamine is a triamine selected from the group consisting of a diethylenetriamine, 1-piperazineethaneamine, and bis(hexamethylene)triamine In further embodiments, the polyamine comprises a tetramine, for example triethylenetetramine, or a pentamine, for example tetraethylenepentamine.

As would be appreciated by those skilled in the chemical arts, a primary polyamine may allow for tuning or modifying of the binder/adhesive composition due to its low steric hindrance. In non-limiting examples, 1,2-diaminoethane, 1,4-diaminobutane, 1,5-diaminopentane, 1,6-diaminohexane, 1,12-diaminododecane, 1,4-diaminocyclohexane, 1,4-diaminobenzene, diethylenetriamine, triethylenetetramine, tetraethylenepentamine, 1-piperazine-ethaneamine, 2-methyl-pentamethylenediamine, 1, 3-pentanediamine, bis(hexamethylene)triamine, and 1,8-diaminooctane exhibit low steric hindrance and may be utilized in the present technology. In one embodiment, the polyamine component comprises a primary polyamine selected from 1,6-diaminohexane (hexamethylenediamine (HMDA)) and 1,5-diamino-2-methylpentane (2-methyl-pentamethylenediamine).

In certain embodiments, the polyamine component primarily or partially comprises a polyether polyamine, and may comprise a diamine or a triamine In one embodiment, the polyether polyamine is a trifunctional primary amine comprising a Jeffamine® such as the Jeffamine® T-403 polyetheramine, or the Jeffamine® EDR-104 and EDR-148 etheramines (all commercially available from Huntsman Corporation, 10003 Woodloch Forest Drive, The Woodlands, Tex. 77380, USA).

As used herein, the term “solvent” may include any solvent or solvent system capable of facilitating one or more reactions between the carbohydrate component and the polyamine component. For example, the solvent may be water, an organic solvent and mixtures thereof. Examples of organic solvents include alcohols, ethers, esters, ketones, aldehydes, alkanes and cycloalkanes.

In further embodiments, the binder/adhesive composition is characterized by a weight ratio between the at least one amine component and the at least one carbohydrate component in a range of about 0.5:1 to about 50:1, include ratios of about 1:1 to about 40:1, about 2:1 to about 30:1, about 3:1 to about 20:1, about 4:1 to about 10:1 and about 5:1 to about 8:1. In certain embodiments, the aqueous

Depending on its chemical composition, the binder/adhesive composition of the instant disclosure may be used as manufactured, i.e. in the absence of further chemical or physical modification, i.e. by applying it to a minable ore, grain or track ballast and allowing for the subsequent curing of the binder/adhesive under ambient conditions. In a further embodiment, the binder/adhesive composition may be used by subsequently adding a crosslinker, applying the mixture onto a minable ore, grain or track ballast and allowing the mixture to cure, thus forming a highly crosslinked polymeric binder/adhesive having similar or even improved properties over previously described binders. In certain embodiments, the composition of the present application may advantageously be prepared, stored and/or shipped, and used later and/or at a different place by adding a crosslinker, to complete the final binder/adhesive composition.

A further aspect of the disclosed technology relates to a method of manufacturing a transportable solution of the binder/adhesive composition disclosed herein, comprising the steps of: (i) mixing in a solvent with the curable binder composition disclosed herein; and (ii) transferring the resulting solution to a container or storage vessel.

In one embodiment, the preparation of the binder/adhesive composition is carried out in a solvent, such as water, to directly yield a binder solution usable for storage, shipping or as a basis for preparing the disclosed (final) binder/adhesive composition. For example, the composition may be prepared in a concentrated aqueous solution of the carbohydrate and amine components. The resulting binder/adhesive concentrate solution may then be stored and/or transported for later use, e.g. by dilution and addition of a crosslinker, as an effective binder for treating compositions of interest, including minable ore compositions such as coal, oil shale, metals, gemstones, limestone, chalk, dimension stone, rock salt, potash, gravel, and clay.

In some embodiments, the chemical components comprising or consisting of the disclosed binder or adhesive may be combined in a single reaction step (and in a single reaction vessel). For example, the carbohydrate reactant(s) and the amine reactant(s) of the binder composition may be combined in a single preparation step, for example by dissolving the carbohydrate reactant(s) in water and then adding the amine reactant(s). The term “single preparation step” is used herein to differentiate from a “multiple preparation step” preparation in which a first portion of reactants are combined and stored and/or allowed to react for a pre-determined time before addition of further reactants.

For instance, in certain embodiments, the carbohydrate reactant(s) and the amine reactant(s) of the binder composition may be combined by 1) combining all of the carbohydrate reactant(s), with a first portion of the amine reactant(s) to provide an intermediate mixture of carbonyl/carbon-oxygen functionalized (carbohydrate) reactant(s) and nitrogen containing (amine) reactant(s); and 2) combining the intermediate mixture of carbonyl/carbon-oxygen functionalized (carbohydrate) reactant(s) and nitrogen containing (amine) reactant(s) with a second portion of the amine reactant(s) to provide the mixture of total carbohydrate reactant(s) and total amine reactant(s). In some embodiments, the reactants may be heated to provide the intermediate mixture of carbohydrate reactant(s) and amine reactant(s); accordingly, the intermediate mixture of carbohydrate reactant(s) and amine reactant(s) may be subsequently cooled.

In some embodiments, the viscosity of the binder/adhesive solution or dispersion following the combination of the at least one carbohydrate component and the at least one amine component comprises a value in a range of about 1-100 centipoise (cP), including about 1-50 cP and 1-10 cP.

The mixing of the carbohydrate and amine components may be carried out at or around atmospheric pressure (about 1 atm (about 760 mm Hg)), for example by mixing the reaction components in a vat or a vessel such as an open or a closed reaction vessel, at atmospheric pressure or at a pressure above atmospheric pressure.

In certain embodiments, the disclosure relates to a water-soluble binder/adhesive composition obtainable by the production and synthetic methods described herein.

In certain embodiments, the binder/adhesive composition disclosed herein is obtainable by mixing the at least one amine component with the at least one carbohydrate component at a temperature of at least about 150° F., such as 180° F. for a period of at least about 10 minutes, including about 15 minutes and about 30 minutes, under constant stirring at ambient pressure conditions (about 1 atm).

For example, in some embodiments the disclosed binder/adhesive is produced by introducing a carbohydrate component, e.g. a dextrin such as STADEX® 126 (available from Tate & Lyle Americas, Hoffman Estates, Ill., USA) to a vat of water heated to a temperature of about 180° F. under constant stirring for about 15 minutes. The amine component, which may comprise urea, is then added to the dextrin/water solution under constant stirring at a temperature of about 180° F. until the urea component is completely dissolved.

In embodiments related to methods of applying the curable binder composition to an article or a composition of matter such as a minable ore, grain or track ballast, the article or a composition of matter is substantially free of the binder/adhesive composition.

In certain embodiments, the binder/adhesive solution or dispersion comprises a crosslinker. In alternative embodiments, the binder/adhesive solution or dispersion may be solvated by or reside in a solvent or solvent system for subsequent combination with a crosslinker, wherein the binder/adhesive solution or dispersion and the crosslinker may be stored in different containers.

The binder composition disclosed herein, whether utilized as a solution or dispersion depending on the material(s) to be bound, may in some embodiments comprise at least 5 wt. %, 10 wt. %, 12 wt. %, or 15 wt. % binder solids; and/or less than 75 wt. %, 70 wt. %, 65 wt. % or 60 wt. %; or less than 50 wt. %, 40 wt. % or 20 wt. % binder solids as determined, e.g. as baked out binder solids by weight after drying at 140° C. for 2 hours or similar protocols known to the skilled artisan.

In further embodiments, a second chemical treatment, e.g. on the surface of minable ore, including but not limited to coal, may be utilized for producing an upper layer/surface on the minable ore. For instance, the second chemical treatment (which may be referred to as a “topper”) may comprise a polymer based composition comprising one or more of latex, vinyl acetate, butyl acrylate, styrene acrylic(s), and combinations thereof, and may be applied to a minable ore loaded into a transport vessel such as a coal car. In certain embodiments, the second chemical treatment or “topper” may comprise one or more of acrylic emulsion (MaxxAcryl), styrene acrylic (MaxxAcryl® and PermaPel), vinyl acrylic and vinyl acetate (Maxxetate®) polymers and compounds available from MCTRON™ Technologies (Greenville, S.C., USA) under the above referenced commercial lines.

In some embodiments, the second chemical treatment may be applied to the top of a minable ore using an automated sprayer system comprising multiple spraying nozzles such as those available from Spraying Systems Company (Wheaton, Ill., USA). The process may be repeated as necessary for treating multiple coal railcars loaded with binder treated coal.

In some embodiments, additives capable of enhancing the performance of the disclosed binder composition that are known to those of skill in the relevant arts may be advantageously incorporated. These additives may include waxes, dyes dedusting oil, release agents, urea, tannins, quebracho extract, ammonium phosphate, bisulfite, water repellent agent, silanes, silicones, lignins, lignosulphonates and non-carbohydrate polyhydroxy components selected from glycerol, polyethylene glycol, polypropylene glycol, trimethylolpropane, pentaerythritol, polyvinyl alcohol, partially hydrolyzed polyvinyl acetate, fully hydrolyzed polyvinyl acetate, and mixtures thereof. Additives are generally not reactants of the binder composition, i.e. additives do not cross-link with the carbohydrate and/or the nitrogen containing reactant(s) (or reaction products thereof) as part of the curing of the binder or adhesive compositions described herein.

In certain embodiments, the binder may include a silicon-containing coupling agent such as those that are commercially available from the Dow-Corning Corporation, Evonik Industries and Momentive Performance Materials. In certain embodiments, the silicon-containing coupling agent may comprise optionally substituted silylethers and/or alkylsilyl ethers, further comprising one or more halide, alkoxyl, phenyl, amino, and additional chemical substituents. In one embodiment, the silicon-containing compound is an amino-substituted silane, such as, gamma-aminopropyltriethoxysilane (also commercially available as (3-amino)triethoxysilane and SILQUEST A-1101; Momentive Performance Materials, Corporate Headquarters: 22 Corporate Woods Boulevard, Albany, N.Y. 12211 USA). In further embodiments, the silicon-containing compound comprises an amino-substituted silane, for example, aminoethylaminopropyltrimethoxy silane (commercially available as Dow Corning® Z-6020 (The Dow Chemical Company, Midland, Mich., USA)), gamma-glycidoxypropyltrimethoxysilane (commercially available as SILQUEST™ A-187 (Momentive Performance Materials Inc., Waterford, N.Y., USA)), or an aminofunctional oligomeric siloxane such as Dynasylan® HYDROSIL 2627 (Evonik Industries, Parsippany, N.J., USA).

In certain embodiments, silicon-containing coupling agents may be incorporated into the disclosed binder/adhesive at a concentration of from about 0.1% to about 1% by weight based upon the dissolved binder/adhesive solids (i.e., about 0.05% to about 3% based upon the weight of the binder solids added to the aqueous solution). As known to those skilled in the relevant art, silicone-containing compounds such as those described herein can beneficially enhance the ability of the binder/adhesive to adhere to the matter to which the binder/adhesive is disposed, minable ore compositions such as coal, oil shale, metals, gemstones, limestone, chalk, dimension stone, rock salt, potash, gravel, and clay.

In some embodiments, the curable binder composition may be applied to a bulk aggregation or collection of a minable ore, including but not limited to a initially t

As used herein, the term “consist or consisting essentially of” is intended to limit the scope of a statement or claim to the specified components, materials, concentrations and/or steps and those that do not materially affect the characteristic(s) of the claimed limitation(s).

### EXAMPLES

Certain embodiments of the disclosed technology are further illustrated below in the following, non-limiting examples.

Example 1. Production of the Binder Composition. An aqueous binder composition as disclosed herein (comprising about 66 wt. % water, about 30 wt. % urea, and about 4 wt. % STADEX® 126 (dextrin)) was produced by first introducing about 200 lbs. STADEX® 126 to a mixing vessel comprising about 3300 lbs. of water under constant stirring conditions at a temperature of about 180° F. and ambient pressure (about 1 atm). Following the stirring of the STADEX® 126 aqueous solution for a time period of about 15 minutes, about 1500 lbs. of urea is added to the solution under constant stirring conditions and constant cooling to about room temperature (about 65-75° F.) until the urea component is completely dissolved (about 10-15 minutes). The resulting solution is then mixed with a surfactant such as dioctyl sulfosuccinate (DOSS) and transferred via pumping into a 550-gallon chemical tote tank for storage and transport.

Example 2. Application of the Binder to Coal. The binder solution of Example 1 is loaded into a first automated sprayer system comprising multiple spraying nozzles such as those available from Spraying Systems Company (Wheaton, Ill., USA) that is operably connected to a coal conveyor belt system such as those available from FEECO International (Green Bay, Wis., USA) and West River Conveyors and Machinery Company (Oakwood, Va., USA). Freshly-mined coal is loaded onto the coal conveyor belt system that is further operably connected to a coal railcar (alternatively referred to as a hopper car or hopper wagon) such as those produced by The Greenbrier Companies (GBX; Lake Oswego, Oreg., USA) and a coal railcar loading system such as those available from CSX Transportation (Jacksonville, Fla., USA). The freshly-mined coal is subjected to a first chemical treatment via spraying the binder composition onto the coal using the multiple spray nozzles arranged in sufficient proximity to the coal conveyor belt system to apply the binder to the surface of the coal and subsequently loaded into a coal railcar for transport. The binder application to the coal advantageously reduces and/or eliminates problems associated with coal loading and transport, including but not limited to dust generation (during loading and/or transport), and thermally induced issues such as coal incineration and/or spontaneous combustion, including “hot spotting.” Additionally, the binder permits the formation of a beneficial “char layer” on the binder treated coal, which may assist in the reduction or elimination of the aforementioned issues.

Example 3. Further Treatment of Transportable Coal Comprising the Binder and

Additional Chemical Treatment. In a further effort to prevent issues such as coal dust generation, coal incineration and/or spontaneous combustion, including “hot spotting,” the coal railcar loaded with binder treated coal may be further treated with the addition of a second chemical treatment on the surface of the coal, which forms the upper layer/surface of the coal as loaded in coal railcar and may be openly exposed to the atmosphere. The second chemical treatment, which comprises a polymer based composition comprising one or more of latex, vinyl acetate, butyl acrylate, styrene acrylic(s), and combinations thereof, is loaded into a second automated sprayer system comprising multiple spraying nozzles such as those available from Spraying Systems Company (Wheaton, Ill., USA) proximal to the coal railcar such that the multiple spraying nozzles are capable of applying the polymer based composition onto the coal surface of the coal railcar loaded with binder treated coal. The process may be repeated as necessary for treating multiple coal railcars loaded with binder treated coal.

What is claimed is:

1. An aqueous curable binder composition comprising:
a) at least one carbohydrate component;
b) at least one amine component; and
c) at least one reaction product comprising one or more reaction products of the at least one carbohydrate component with the at least one amine component;
wherein the aqueous curable binder composition is dispersible under ambient temperature and pressure conditions, and
wherein the aqueous curable binder composition eliminates or reduces moisture loss when applied to an article or composition of matter.

2. The aqueous curable binder composition of claim 1, wherein the at least one carbohydrate component is selected from the group consisting of dextrin, cyclodextrin, branched cyclodextrin, maltodextrin, amylodextrin, alpha (α)-limit dextrin, beta (β)-limit dextrin, British gum, canary/yellow dextrin, icodextrin, starch, modified starch, monosaccharides, disaccharides, polysaccharides.

3. The aqueous curable binder composition of claim 1, wherein the at least one amine component comprises an inorganic amine or an organic amine comprising at least one primary amine group, as well as salts thereof.

4. The aqueous curable binder composition of claim 1, wherein the at least one amine component comprises a primary polyamine of the general formula H₂N-Q-NH₂, wherein Q is selected from an alkyl, cycloalkyl, heteroalkyl, cycloheteroalkyl, benzyl, a C₆ alkyl or cyclohexyl, cyclopentyl, cyclobutyl, or benzyl, optionally substituted with amino, aminoalkyl, hydroxyl, halo, or thiol, wherein alkyl is selected from the group consisting of C₂-C₂₄ alkyl, C₂-C₉ alkyl, and C₃-C₇ alkyl.

5. A minable ore comprising the aqueous curable binder composition of claim 1.

6. The minable ore of claim 5, wherein the minable ore is selected from the group consisting of coal, oil shale, metals, gemstones, limestone, chalk, dimension stone, rock salt, potash, gravel, clay and combinations thereof.

7. The minable ore of claim 5, wherein the minable ore and curable binder composition are capable of forming a char or partial burn layer under mild ignition conditions.

8. The minable ore of claim 5, wherein the curable binder composition forms a continuous film or layer when applied to the minable ore.

9. A grain or track ballast comprising the aqueous curable binder composition of claim 1.

10. The grain or track ballast of claim 9, wherein the aqueous curable binder composition forms a continuous film or layer when applied to the grain or track ballast.

11. A method of manufacturing the aqueous curable binder composition of claim 1, comprising the steps of:
(i) providing at least one carbohydrate component;
(ii) providing at least one amine component;
(iii) introducing the at least one carbohydrate component into a stirring vessel comprising a solvent or solvent system under stirring and applied heating conditions; and
(iv) introducing the at least one amine component to the at least one carbohydrate component/solvent or solvent system solution under stirring and applied cooling conditions.

12. The method of claim 11, wherein the carbohydrate component comprises dextrin and the amine component comprises urea.

13. The method of claim 12, wherein the aqueous curable binder composition comprises about 2-5% by dry weight dextrin and 25-35% by dry weight urea.

14. The method of claim 11, further comprising adding a surfactant to the aqueous curable binder composition.

15. A curable binder solution or dispersion comprising the curable binder composition of claim 1 in a solvent or solvent system.

16. The curable binder solution or dispersion of claim 15, wherein the solvent or solvent system comprises one or more of water, alcohol, methanol, ethanol, propanol, butanol, ammonia and combinations thereof.
